(19) United States
(12) Patent Application Publication
(10) Pub. No.: US 2026/0063037 A1
(43) Pub. Date: Mar. 5, 2026

(54) VANE FOR A VANE CELL MACHINE, METHOD FOR PRODUCING VANES, AND VANE CELL MACHINE

(71) Applicant: Danfoss A/S, Nordborg (DK)

(72) Inventors: Poul Erik Hansen, Aabenraa (DK); Georg Enevoldsen, Nordborg (DK); Achuthan Babu, Nordborg (DK)

(21) Appl. No.: 19/272,349

(22) Filed: Jul. 17, 2025

(30) Foreign Application Priority Data
Aug. 30, 2024 (EP) 24197644.8

(51) Int. Cl. F01C 21/08

(52) U.S. Cl. CPC F01C 21/0881

(57) ABSTRACT

The present disclosure relates to a vane (30) for a vane cell machine (1). The vane (30) includes a body (31) extending in a longitudinal direction (LD), a traverse direction (TVD), and a thickness direction (THD), wherein all directions (LD, TVD, THD) are at least substantially perpendicular to each other. It includes two opposite longitudinal end surfaces (32) along the longitudinal direction (LD) and an outer side (33) for sealing against an inner circumferential wall surface (12) of the stator (10), wherein the outer side (33) constitutes one end of the body (31) in the traverse direction (TVD). For optimizing the efficiency of the vane cell machine and to improve the manufacturability of the vanes, the body (31) is made of solid fiber polymeric composite and the vane (30) includes at least one weight insert (42), wherein at least one cavity (41) for insertion of the at least one weight insert (42) into the body (31) is formed in the body (31). The present disclosure further relates to a vane cell machine (1) and a method for producing vanes (30).

### CROSS-REFERENCE TO RELATED APPLICATIONS

This application claims foreign priority benefits under 35 U.S.C. § 119 to European Patent Application No. 24197644.8 filed on Aug. 30, 2024, the content of which is hereby incorporated by reference in its entirety.

### TECHNICAL FIELD

The present invention relates to a vane for a vane cell machine, wherein the vane cell machine includes a stator with a stator bore and a rotor arranged rotatably in the stator bore, the stator having an inner circumferential wall surface. Further, the present invention relates to a vane cell machine and a method for producing vanes.

### BACKGROUND

A vane cell machine is described, for example, in U.S. Pat. No. 10,415,565 B2.

A vane cell machine comprises a rotor and a stator. The rotor is located in a stator bore of the stator. A rotational axis of the rotor has a distance to a middle axis of the stator bore. An outer limitation of the stator bore is formed by a circumferential wall of the stator and two axial end faces of the stator. Several vanes are rotationally coupled to the rotor. In operation of the vane cell machine, outer sides of the vanes slide along a circumferential wall of the stator, in more detail along an inner circumferential wall surface of the stator. Fluid chambers (sometimes also referred to as pressure chambers) are formed in the stator bore between the rotor, the vanes, and the circumferential wall of the stator bore. The chambers are limited along an axial direction of the rotor (and the stator bore) by said axial end faces of the stator.

In operation, the vanes rotate together with the rotor about the rotational axis of the rotor. In addition, the vanes are moved radially inwardly and outwardly relative to the rotor, in more detail relative to the rotational axis. During each revolution of the rotor, the chambers increase and decrease their volumes. The individual pressure chamber is subject to a period of increasing volume (increasing period) and a period of decreasing volume (decreasing period) during each revolution.

If such a vane cell machine is used as a pump, fluid is supplied to the vane cell machine. The fluid is sucked into the chamber from a fluid inlet of the vane cell machine during the increasing period of the respective chamber. At least during and end of the decreasing period, the fluid is pushed out of the chamber towards an outlet of the vane cell machine. Additionally, the fluid may be compressed during the decreasing period.

If such a vane cell machine is used as a fluid motor, pressurized fluid is provided into the vane cell machine. The pressurized fluid flows into the chambers and expands therein during the increasing periods, thereby driving the rotation of the rotor. Then the fluid is discharged from the vane cell machine.

It is known to form vanes for vane cell machines by first providing a steel core and then over-molding the steel core with a polymer. The steel core provides mechanical stability. The polymer can improve the friction properties and protect the steel core from damages, e.g. due to corrosion. However, the manufacturing process of such vanes is cost-intensive and has a low degree of flexibility.

### SUMMARY

The problem of the present invention is to provide vanes for optimizing the efficiency of a vane cell machine and to improve the manufacturability of the vanes.

This problem is solved by a vane having the features of claim 1.

The vane is for a vane cell machine, wherein the vane cell machine includes a stator with a stator bore and a rotor arranged rotatably in the stator bore, the stator having an inner circumferential wall surface.

The vane comprises a body. The body extends in a longitudinal direction, a traverse direction, and a thickness direction. All directions may be at least substantially perpendicular to each other. The body (and hence the vane) comprises two opposite longitudinal end surfaces along the longitudinal direction and an outer side for sliding against the inner circumferential wall surface of the stator, wherein the outer side constitutes one end of the body (and hence of the vane) in the traverse direction.

According to the present invention, the body is made of solid fiber polymeric composite and the vane comprises at least one weight insert, wherein at least one cavity for insertion of the at least one weight insert into the body is formed in the body.

In other words, the body includes at least one cavity for insertion of the at least one weight insert.

The present invention allows to provide vanes for optimizing the efficiency of a vane cell machine. Further, it improves the manufacturability of the vanes. These aspects are described in more detail in the following.

As explained above, conventional vanes can be formed by providing a steel core and over-molding the steel core with a polymer. However, a specific over-molding tool for over-molding the steel core with the polymer must be provided for each vane type. The over-molding tool must be specifically adapted to the size and the shape of the individual vane type. In other words, for each vane type, an individual over-molding tool must be designed and manufactured. It often takes a long time until the appropriate over-molding tool for a new vane type is available. This considerably jeopardizes the flexibility in manufacturing different vane types. Furthermore, such over-molding tools are expensive. This is an economic disadvantage, especially with regard to vane types that are produced in small quantities only, for example particularly large vanes.

With the present invention, the vane is manufactured without over-molding. The vane can be free of overmolded parts.

The whole body is made only of the fiber polymeric composite. Especially, the whole vane except the weight insert(s)—and, if applicable, the corresponding fixation of the weight insert(s)—can be made only of the fiber polymeric material.

The fiber portion increases the mechanical stability and the reliability of the body and hence of the vane. The fiber polymeric composite has a high corrosion resistance. In particular, the vane can be configured for the use with sea water.

The vane can be manufactured easily, with low costs and with high flexibility.

Especially, the whole body can be formed easily by using flexible and cheap manufacturing methods.

According to one aspect, the body can be manufactured by providing a single precursor body made of the fiber polymer material and by forming the body from the precursor body by machining. For example, the precursor body can be of a simple geometric shape, e.g. of (at least substantially) cuboid shape. Such a precursor body can be manufactured cost-efficiently and with high flexibility regarding its size.

With the present invention, the desired (final) shape of the body can be obtained by machining, e.g. from such a precursor body. This allows for considerably higher cost-efficiency and flexibility compared to over-molding, especially if vanes of different sizes and/or shapes are produced. For example, the machining can include CNC milling.

Especially, the shape of the body can be obtained by machining to match corresponding geometries of the vane cell machine, e.g. length, width, and thickness. Additionally or alternatively, other geometric features of the body, e.g. grooves, the shape of the outer side, and/or the like can be obtained with high flexibility and low costs.

Some further possible manufacturing aspects are described below with respect to the manufacturing method.

The omission of the steel core decreases the mass of the vane. A mass density of the fiber polymeric composite is less than a mass density of steel. This helps to reduce friction and wear. Further, this facilitates obtaining a better efficiency of the vane cell machine.

Rotation of the rotor can be started and stopped with less effort.

However, the research underlying the disclosure has shown that the volumetric efficiency of a vane cell machine can decrease if the mass of the vanes used therein is particularly low. This can easily happen if the whole body is formed from fiber reinforced composite only without taking further measures.

In the vane cell machine, a vane mounting of the rotor fixes the vane to the rotor rotationally but allows for limited displacement of the vane along a radial direction (relative to the rotational axis of the rotor). The vane is rotationally coupled to the rotor and rotates/moves along a circumferential direction during operation. The outer side of the vane is configured to slide against and seal against the inner circumferential wall surface of the stator. Two adjacent vanes (seen along the circumferential direction) form part of an enclosure of one (pressure) chamber of the vane cell machine. For allowing the chamber's volume to increase, the vane mounting allows the vane to move radially outwardly with respect to the rotational axis. For allowing the chamber's volume to decrease, the mounting allows the vane to move back radially inwardly with respect to the rotational axis. At least a part of a sealing force that is necessary for sealing of the outer side of the vane against the inner circumferential wall surface of the stator is provided by a centrifugal force acting on the vane due to its rotation about the rotational axis. This centrifugal force pushes the vane radially outwardly (with respect to the rotational axis of the rotor). Hence, the centrifugal force assist in pushing the outer side of the vane against the inner circumferential wall surface of the stator. Thereby, the corresponding centrifugal force, which results from a mass (a weight) of the vane and the rotation, at least contributes to proper sealing between the vane and said inner circumferential wall surface.

If the mass of the individual vane is too low, the centrifugal force urging the vane radially outwardly during operation is too low. Proper sealing between the outer side of vane and the inner circumferential surface of the stator is not ensured. Inner leakage between adjacent fluid chambers results in decreased volumetric efficiency. This is especially relevant in vane cell machines that are free of additional biasing springs for urging the vanes radially outwardly with respect to the rotational axis of the rotor. It is noted that such additional biasing springs make the production more complex, increase the production costs, need space, and constitute an additional source for failures. Naturally, if an abutment force of the vanes onto the inner circumferential wall surface is higher than necessary for proper sealing, this induces unnecessarily high friction and hence reduces the efficiency.

In addition, thicker vanes have an impact on the resistance for the fluid to enter and leave the pump, in particular in the case that corresponding channels are located in the axial end faces of the stator.

Furthermore, it is advantageous if all vanes in the vane cell machine have the same mass. This is beneficial for smooth running of the rotor. If the masses of the vanes in the same vane cell machine differ, this can cause vibrations in operation and can decrease the lifetime.

However, it is very difficult to ensure a uniform mass of all vane bodies during manufacturing of the bodies.

With the disclosed approach, this is not a problem anymore. As noted above, the vane comprises at least one weight insert, wherein a cavity for insertion of the weight insert into the body is formed in the body.

The mass of the vane can be precisely adjusted with the weight insert(s). In other words, the mass of the vane is adjusted (tuned) by the weight insert(s). This allows to obtain a vane with the optimized mass. There is a sweet spot for the vane's mass, wherein the mass is, on the one hand, as low as possible but, on the other hand, high enough to ensure proper sealing in operation (by causing sufficient strong centrifugal force).

The mass of the vane can be adjusted to a predetermined target mass by adjusting the mass of the weight insert and then inserting the weight insert into the vane, in more detail in the cavity. In this way, individual masses of all vanes of the van cell machine can be easily adjusted to the same target mass. For example, the mass of the individual body is measured, and the weight insert is provided with a mass corresponding at least substantially to a difference between the mass of the body and the target mass of the vane. Another approach is to provide small weight inserts, wherein several weight inserts can be inserted into the at least one cavity. In this case, the mass of the vane can be easily adjusted by inserting a number weight inserts into the at least one cavity such that the (total) mass of the vane—i.e. with the body and the insert(s)—matches as closely as possible to the target mass. This can also be of advantage if individual old vanes in a vane pump shall be replaced. Even if there would be weight differences between the old vanes and the replacement vanes, the weights of the replacement vanes according to the present invention can be easily adapted.

Another advantage with of present solution is that it is particularly easy to separate the different materials, e.g. an end of a lifetime of the vane cell pump. In case of a steel core overmolded with polymer, it is very difficult to separate the polymer and the steel core. Hence, the present invention facilitates proper disposal and the proper recycling of materials of the vane.

According to one aspect, the at least one cavity can be formed in the body by partial removal of the fiber polymeric composite, e.g. by machining. For example, the at least one cavity is drilled into the body. This allows cost-effective production of the body with the cavity.

In one embodiment, the at least one cavity comprises a round, circular cross section.

This is particularly easy to produce.

The at least one cavity has an opening. The opening facilitates inserting the at least one weight insert into the empty at least one cavity.

The cavity may extend along a cavity axis. The cavity axis may be at least substantially parallel to the longitudinal axis.

According to one aspect, a minimum wall thickness of the body around the at least one cavity is 1 mm (except at the opening of the cavity). This ensures sufficient structural integrity of the body.

In one embodiment, the at least weight insert has been inserted into the at least one cavity. Hence, a customer does not need to insert the weight insert into the at least one cavity and to maybe fix it therein. This improves the user-friendliness.

The at least one weight insert may be rod-shaped. This shape is easy to produce and easy to insert into the cavity. Furthermore, the mass of the weight insert can be varied easily by producing longer or shorter rods. Adjusting the mass of the at least one weight insert may include selecting the weight insert from a set of rods of different lengths and/or shortening a rod to an appropriate length.

In one embodiment, the at least one cavity is arranged off-center towards the outer side relative to a central longitudinal axis of the body. In other words, the at least one cavity is in proximity of a sealing surface which is configured to provide a sliding seal between the vane and the circumferential wall of the stator. Especially, the at least one cavity is arranged in a radially outer end portion of the vane if the vane is mounted in the vane cell machine. This increases the effect of the at least one weight insert (which is inserted into the at least one cavity) onto the centrifugal force and onto the sealing of the vane against the inner circumferential side wall of the stator in operation. The longitudinal axis may be parallel to the longitudinal direction. Especially, “longitudinal axis” may mean a middle axis/central axis of the vane body extending in parallel to the longitudinal direction. The longitudinal axis may extend between the two longitudinal end faces of the body.

According to one aspect, the at least one cavity opens at one of the longitudinal end faces (e.g. at a first longitudinal end face). In other words, the at least one cavity has an opening at the one of the longitudinal end faces. The at least one weight insert can be inserted (or have been inserted) from the one of the longitudinal end faces. The at least one weight insert cannot be forced out of the opening of the cavity by the centrifugal force and/or by forces arising from the back and forth radial displacement of the vane with respect to the rotational axis.

In one embodiment, the at least one cavity extends from (the) one of the longitudinal end faces along the longitudinal direction into the body. Each longitudinal end face is configured to interact with the corresponding one of the axial end faces of the stator bore of the vane cell machine. As described above, the vane is configured to move radially into and out of the rotor of the vane cell machine. This movement is perpendicular to the orientation of the cavity, in particular to the cavity axis, such that there is no movement of the vane in the direction of the cavity axis. Therefore, the weight insert cannot escape the cavity, even in case it is loose. Furthermore, the additional centrifugal force applied by the at least one weight insert is distributed more uniformly along the longitudinal direction. This improves sealing and reduces internal stresses in the body in operation.

In one embodiment, a length of the at least one cavity (e.g. along the longitudinal direction) is at least 0.2 mm longer than a length of the weight insert. Additionally or alternatively, the at least one weight insert may have been inserted into the at least one cavity and may be recessed relatively to the one of the longitudinal end faces of the body, e.g. by at least 0.2 mm. This reduces the risk of a collision of the at least one weight insert with parts of the stator in operation, e.g. with one of the axial end faces of the stator bore.

According to one aspect, the vane can comprise several weight inserts. For example, the vane can include at least two or at least four weight inserts.

If the vane comprises several weight inserts, each weight insert can be in accordance with any one of the features, embodiments, and modifications described with respect to the at least one weight insert. The advantages apply accordingly. Different weight inserts can be in accordance with different ones of the features, embodiments, and modifications as described with respect to the at least one weight insert. However, at least some of the weight inserts and even all weight inserts can be of the same type.

Additionally or alternatively, several cavities for insertion of weight inserts into the body may be formed in the body. For example, at least two or at least four cavities for insertion of weight inserts (e.g. respectively at least one weight insert) may be formed in the body. This increases the freedom of adjusting the mass of the vane.

Cavities can be formed in different sections of the vane.

If several cavities for insertion of weight inserts into the body are formed in the body, each cavity can be in accordance with any one of the features, embodiments, and modifications described with respect to the at least one cavity. The advantages apply accordingly. Different cavities can be in accordance with different ones of the features, embodiments, and modifications as described with respect to the at least one cavity.

However, at least some of the cavities and even all cavities can be of the same type.

The cavities and/or the weight inserts can be used to affect a position of a center of mass of the vane.

By providing multiple cavities, several weight inserts can be placed in different cavities. This allows to balance the vane in accordance with predefined requirements.

The weight insert(s) provide(s) sufficient additional mass to the vane, such that the increased centrifugal force occurring in operation ensures proper sealing between the vane and the circumferential surface of the stator bore. Depending on the characteristics of the vane, respectively the vane cell machine, weight inserts having predefined weights can be provided, such that a required sealing contact is archived. It is clear that the mass of the vane can be adapted by using correspondingly weighted weight inserts. This allows an easy adaptation of the sealing pressure.

By providing the at least one the weight insert (or several weight inserts) into the body of the vane, in particular into the at least one cavity (or several cavities), the vane is especially suitable for use in vane cell machines, in which the vanes are pressed to the stator bore by means of centrifugal force only.

In one embodiment, the body comprises (at least) a further cavity (a second cavity) extending from the other one of the longitudinal end faces along the longitudinal direction into the body. The at least one cavity and the further cavity can be distanced to each other along the longitudinal direction. Such an arrangement results in a balanced vane since weight inserts can be provided in the vicinity of both opposite longitudinal end faces. In other words, the body comprises at least two cavities extending from opposite longitudinal end faces of the body along the longitudinal direction, wherein the cavities are distanced to each other. For example, the at least one cavity (a first cavity) is provided at the first longitudinal end face of the body, wherein the second cavity is provided at the other one of the longitudinal end faces of the body. Both cavities may extend along a shared axis. The shared axis may be parallel to the longitudinal direction. In one embodiment, these cavities do not intersect with each other.

According to one aspect, the body comprises, on a side face forming one end of the body in the thickness direction, grooves extending in the traverse direction. The present invention improves the flexibility regarding the design of the grooves.

The grooves may have a depth of at least 31% of the thickness of the body along the thickness direction, e.g. of at least 35%. Additionally or alternatively, the grooves have a depth of up to 45% of the thickness of the body, maybe up to 40%. The grooves may be formed by partial removal of the fiber polymeric composite (e.g. from a precursor body), for example by machining. Ridges can be formed between adjacent grooves. In an assembled state, in which the vane is arranged within the rotor of the vane cell machine, the grooves from a fluid connection between one of the adjacent fluid chambers and a displacement space arranged in radial direction between the vane and the axis of rotation. The displacement space is needed for allowing the vane to displace radially inwardly during the decreasing period. A larger depth reduces a flow resistance between the displacement space and the adjacent fluid chamber. Thus, fluid can easily escape from the displacement space into the pressure chamber via the grooves when the vane is pushed in the radial direction towards the rotational axis (during the decreasing period). In conventional vanes, a maximum depth of the grooves is limited. It would be quite difficult to form the grooves by machining with such a large depth. The large depth would exceed a thickness of the over-molded polymer cover. Hence, both the polymer and the steel core would have to be machined. Further, the large holes in the polymer cover that would be created could compromise the mechanical stability of the vane. Grooves with larger depth and hence increased “effective area” for fluid flow decrease torque pulsations onto the rotor in operation. This is beneficial. For example, the operation of the vane cell machine as a vane pump is less demanding for a motor driving the rotor.

According to one aspect, the at least one weight insert is formed of a material having a higher mass density than the fiber polymeric composite. For example, a mass density of the material of the weight insert might be at least 4 g/cm³. As noted above, the mass of the vane is adjusted by the at least one weight insert. Especially if the mass density of the material of the weight insert is particularly high compared to the fiber polymeric composite, a significant percentual increase of the mass of the vane can be obtained even with a weight insert of small size.

The at least one weight inserts can be made of steel, bronze, highly filled plastics, etc. The material may be chosen depending on the fluid with which the vane cell is used, the required weight, and space requirements. In one embodiment, the at least one weight insert is formed of stainless steel, especially from salt-water resistant stainless steel. Stainless steel has a sufficiently high mass density.

According to one aspect, the fiber polymeric composite includes polyether ether ketone (PEEK). PEEK has good friction characteristics, especially when used in combination with water or other fluids.

Additionally or alternatively, the fiber polymer composite includes carbon fibers.

Carbon fibers result in a good structural strength.

In one embodiment, the fiber polymeric composite includes PEEK and carbon fibers.

Especially, the fiber polymeric composite may (at least substantially) consist of PEEK and carbon fibers. The combination of PEEK and carbon fibers allows for a good sliding contact while providing high stability and reliability.

According to one aspect, the fiber polymeric composite is a laminated composite.

In one embodiment, the fiber polymeric composite is formed of a laminate with fiber directions offset at 900 to each other. Both fiber directions may be parallel to a plane defined by the longitudinal direction and the traverse direction. This orientation results in a stable vane. For example, a first fiber direction is in the longitudinal direction, while a second fiber direction is in the traverse direction. There are several different manufacturing methods to process a laminate. Depending on the number of vanes and their dimensions, the laminating process might be performed by hand, in an automated manner, or partly by hand and partly in an automated manner. This has a high degree of flexibility.

The laminate may be manufactured from crosswise oriented unidirectional fiber plies of and/or from woven fiber plies with two orthogonal fiber directions.

In one embodiment, the at least one weight insert is fixed within the at least one cavity, in particular by means of an adhesive. The term “adhesive” may be synonymously used for any bonding agent. The at least one weight insert is for example retained by means of the adhesive, which forms a connection between the body and the at least one weight insert. Other retaining means are for example a press fit or a form fit by means of a threaded weight insert. A thermal press-fit is possible. By fixing the at least one weight insert to the body, the at least one weight insert is prevented from moving inside the at least one cavity and from detaching from the body.

According to one aspect, a mass of at least one weight insert may correspond to at least 8% of a mass of the vane without any weight inserts. Additionally of alternatively, the mass of the at least one weight insert for the vane may correspond to 80% of the mass of the vane without any weight inserts at the maximum.

According to one aspect, a total mass of all the weight inserts for the vane may correspond to at least 30% of a mass of the vane without any weight inserts. Additionally of alternatively, the total mass of all the weight insert for the vane may correspond to 120% of the mass of the vane without any weight inserts.

Further, the problem mentioned above is solved by a vane cell with the features cording to claim 11.

The vane cell machine comprises
a housing having a stator with a stator bore;
a rotor mounted in the stator bore and configured for rotation relative to the stator about a rotational axis; and
a plurality of vanes mounted to the rotor such that the vanes are rotationally fixed to the rotor but such that limited displacement of the vanes in a radial direction is allowed;
wherein at least one of the is a vane according to the present invention.

The embodiments, modifications, and advantages described with regard to the vane may apply accordingly with respect to the vane cell machine, and vice versa.

Preferably, several of or even all of the vanes are according to the present invention.

Especially, several of the vanes or all of the vanes may be of the same type.

In one embodiment, relative weight differences between the vanes are less than 5% by weight. This allows to keep imbalances of the rotor with the vanes during operation to a minimum. Furthermore, the vanes wear out evenly, such that all vanes can be replaced at once. This reduces the maintenance effort.

Further, the problem mentioned above is solved by a method for producing vanes, preferably according to the present invention, with the features of claim 13.

This method comprises the following steps:
providing a body of the vane, wherein the body is made of solid fiber polymeric composite;
forming, in the body, at least one cavity for insertion of at least one weight insert; and
inserting the at least one weight insert into the empty at least one cavity.

This method offers high flexibility to produce vanes of different types (e.g. of different sizes and/or shapes) fast and in a cost-efficient manner. Further, it allows to produce vanes for optimizing the efficiency of vane cell machines by adjusting the mass of the vane.

The embodiments, modifications, and advantages describe with respect to the vanes and/or the vane cell assembly may apply accordingly with respect to the method, and vice versa.

In addition, the method can comprise the step of fixing the at least one weight insert in the at least one cavity, e.g. by means of adhesive.

The method can comprise machining of the body.

In particular, the method can comprise forming the body from a single precursor body made of the fiber polymeric composite by machining.

The method can comprise providing the single precursor body made of the fiber polymer material. For example, the precursor body can be of a simple geometric shape, e.g. of (at least substantially) cuboid shape.

The method can include lamination, e.g. by using prepregs, for producing the fiber polymeric material. Alternatively, providing the body can include injection molding or any other manufacturing method being able to provide a body (or precursor body) formed of fiber polymeric composite.

The at least one cavity may be formed to extend from a longitudinal end face of the body along a longitudinal direction of the body.

The method can include machining the at least one cavity in the body, e.g. by drilling. Alternatively, the at least one cavity can be manufactured during the production of the fiber polymeric composite, e.g. during production of the precursor body.

In one embodiment, the mass of the vane (the weight of the vane) is tuned towards a target mass by inserting the at least one weight insert. The at least one weight insert may be provided based on a difference between the mass of the body and the target mass and/or such that the mass of the vane (including the mass of the body and all weight inserts) matches the target mass for the vane.

The method may include one of, several, or all of the following steps:
Determining the mass of the body being equipped with the at least one cavity (the cavities) without the at least one weight insert (the weight inserts), e.g. by weighing the body;
determining a mass difference between the target mass of the vane and the mass of the body; and
Providing the at least one weight insert (the weight inserts) based on the mass difference.

The respective weight insert may be provided using one of, several, or all of the following approaches:
Selection from a set of weight insert(s) having different masses (e.g. of different sizes and/or of different materials with different mass densities);
adjusting the mass of the weight insert, e.g. decreasing the mass by machining the weight inserting; and
producing the weight insert with the mass as needed.

The method can include balancing the vane using the at least one weight insert, especially using at least two weight inserts. The balancing helps optimize the position of the center of mass of the vane and hence to ensure that an abutment force al onto the inner circumferential wall surface of the stator is particularly uniform at the outer side along the longitudinal direction.

The balancing may include any one of, several of, or all of the following:
adjusting the position of the at least one cavity in the body;
adjusting a position of the at least one weight insert within the at least one cavity; and/or
adjusting the masses of weight inserts inserted into the cavity/the cavities at different positions in the body relative to each other.

In one embodiment, grooves are machined into the body. Depending on the characteristics of the vane cell machine, the grooves can be easily adapted. This allows to form different vanes from one type of (precursor) body. This is cost effective and allows a good flexibility.

Additional features, advantages, and possible applications of the invention result from the following description of exemplary embodiments and the drawings. All the features described and/or illustrated graphically here form the subject matter of the invention, either alone or in any desired combination, regardless of how they are combined in the claims or in their references back to preceding claims.

### BRIEF DESCRIPTION OF THE DRAWINGS

The invention is described below with reference to a preferred embodiment in combination with the drawings. Herein shows:

FIG. 1 A vane cell machine;

FIG. 2 a perspective view of a vane used in the vane cell machine in FIG. 1;

FIG. 3 a view onto a side surface of the vane in FIG. 2;

FIG. 4 a cross-sectional view of the vane at section B-B in FIG. 3;

FIG. 5 a view onto a longitudinal end face of the vane in FIG. 2; and

FIG. 6 a cross-sectional view of the vane at section A-A in FIG. 5.

### DETAILED DESCRIPTION

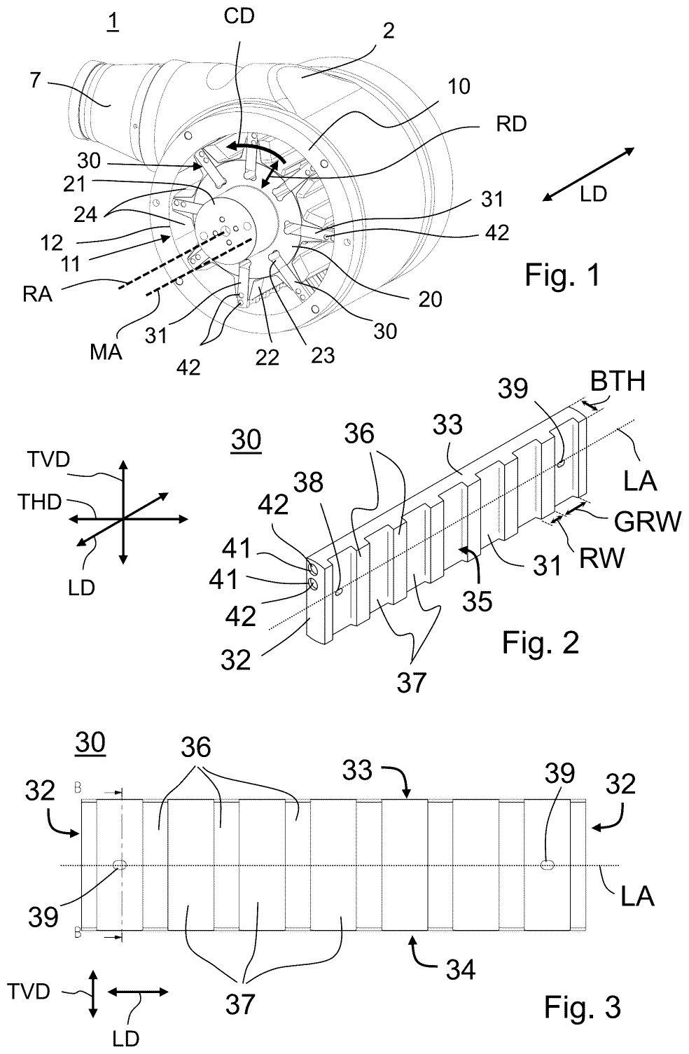

FIG. 1 shows a vane cell machine 1 with a housing 2. The vane cell machine 1 may be configured for use with a fluid, e.g. salt/sea water. The van cell machine 1 can be configured to work as fluid pump and/or as fluid motor. The housing 2 includes a stator 10 with a stator bore 11. A radially outer limitation of the stator bore 11 is formed by a circumferential wall of the stator 10, in more detail by an inner circumferential wall surface 12 of the stator 10, and by two axial end faces (not shown) of the stator 10.

The vane cell machine 1 comprises a first fluid port 7 and a second fluid port (not shown). Depending on whether the vane cell machine 1 operates as fluid pump or as fluid motor, the first fluid port 7 is used as a fluid inlet and the second fluid port is used as a fluid outlet or vice versa.

A rotor 20 is mounted rotatably in the stator bore 11. The rotor 20 is configured to rotate around a rotational axis RA. The rotational axis RA is parallel to a longitudinal axis LD of the vanes 30 and parallel to a middle axis MA of the stator bore 11. The rotational axis RA of the rotor 20 is offset with respect to the middle axis MA of the stator bore 11. The vane cell machine 1 comprises a rotor shaft 21 for coupling the rotor 20 to a motor (not shown) for driving the rotor 20 and/or to a power consumer to be driven by the rotor 20, e.g. a generator. The rotor shaft 21 can be formed integrally with the rotor 20.

A plurality of vanes 30 is mounted to the rotor 20. For each vane 30, the rotor 20 comprises a corresponding vane mount 22. The vane mount 22 allows for limited displacement of the vane 30 along a radial direction RD with respect to the rotational axis RA but rotationally fixes the vane 30 to the rotor 20. Each vane mount 22 comprises a displacement space 23 that is formed in the rotor 20 at a radially inner side of the vane 30 (which corresponds to an inner side 34 of the vane 30 along a transverse direction TVD in FIGS. 3 to 6).

In operation of the vane cell machine 1, the vanes 30 and the rotor 20 rotate together about the rotational axis RA. Accordingly, the vanes 30 rotate/move along a circumferential direction CD. Outer sides of the vanes 30 slide along the circumferential wall of the stator 10, in particular along its inner circumferential wall surface 12.

Pressure chambers 24 (fluid chambers 24) are formed between two adjacent vanes 30 (adjacent along the circumferential direction CD), the rotor 20, and the circumferential wall of the stator 10, in particular the inner circumferential wall surface 12. During a revolution, depending on their rotational positions, the vanes 30 partially retract into the displacement spaces 23 while volumes of the adjacent pressure chambers 24 decrease and move radially outwardly with respect to the rotational axis RA to maintain sealing contact with the inner circumferential wall surface 12 while the volumes of the adjacent pressure chambers 24 increase.

FIG. 2 shows a schematic perspective view of the vane 30. The vane 30 consists of a body 31 and weight inserts 42.

The body 31 and hence the vane 30 extend along the longitudinal direction LD, the transverse direction TVD, and a thickness direction THD. The transverse direction TVD and the thickness direction THD are perpendicular to the longitudinal direction LD, respectively. The thickness direction THD is perpendicular to the transverse direction TVD.

At a side surface 35 of the body 31 in the thickness direction THD, the body 31 comprises grooves 37 and ridges 36 extending in the traverse direction TVD of the body 31.

The body 31 has two longitudinal end faces 32 along the longitudinal direction LD. Only one of the longitudinal end faces 32, referred to as the first longitudinal end face 32, can be seen in FIG. 2.

Each of the longitudinal end faces 32 is provided with openings of two cavities 41 formed in the body 31. Each cavity 41 is of at least substantially cylindric shape; it extends along the longitudinal direction LD, starting from the corresponding longitudinal end face 32.

The vane 30 further comprises an outer side 33 which extends in the longitudinal direction LD and substantially along the thickness direction THD. The outer side 33 can be curved along the thickness direction THD, for example as shown in the exemplary embodiment. FIG. 1 does not show the reference sign 33 but the outer side 33 is a radially outer end of the respective vane 30 and slides against the inner circumferential wall surface 12. The outer side 33 and the inner side 34 of the body 31 constitute opposite sides of the body 31 along the transversal direction TVD.

FIG. 3 shows a schematic side view of the vane 30, in more detail a view onto the side surface 35 (see FIGS. 2, 4, and 5) with grooves 37 and ridges 36. The grooves 37 and the ridges 36 are arranged in an alternating manner. The individual grooves 37 and ridges 36 extend on the side surface 35, linearly along the traverse direction TVD. A groove width GRW (along the longitudinal direction LD) of the grooves 37 may be approximately (plus minus 10%) twice a ridge width RW (along the longitudinal direction LD) of the ridges 12.

FIG. 5 shows a schematic side view onto the first longitudinal end face 32 of the vane 30. The (first) longitudinal end face 32 is equipped with the two cavities 41. Both cavities 41 are arranged off center in the traverse direction TVD with respect to a longitudinal axis LA of the body 31, in particular towards the outer side 33. The longitudinal axis LA can be seen better in FIG. 2. In more detail, the cavities 41 are arranged in an end portion of the body 31 along the transverse direction TVD with the outer side 33.

Further, the cavities 41 are arranged off center in the thickness direction THD, in particular away from the side surface 35. This avoids intersection of the cavities 41 with the grooves 37. A remaining “wall thickness” of the body 31 around the respective cavity 41 is larger than 1 mm everywhere (except at the opening of the cavities 41 located in the longitudinal end face 41), especially at the side surface 35.

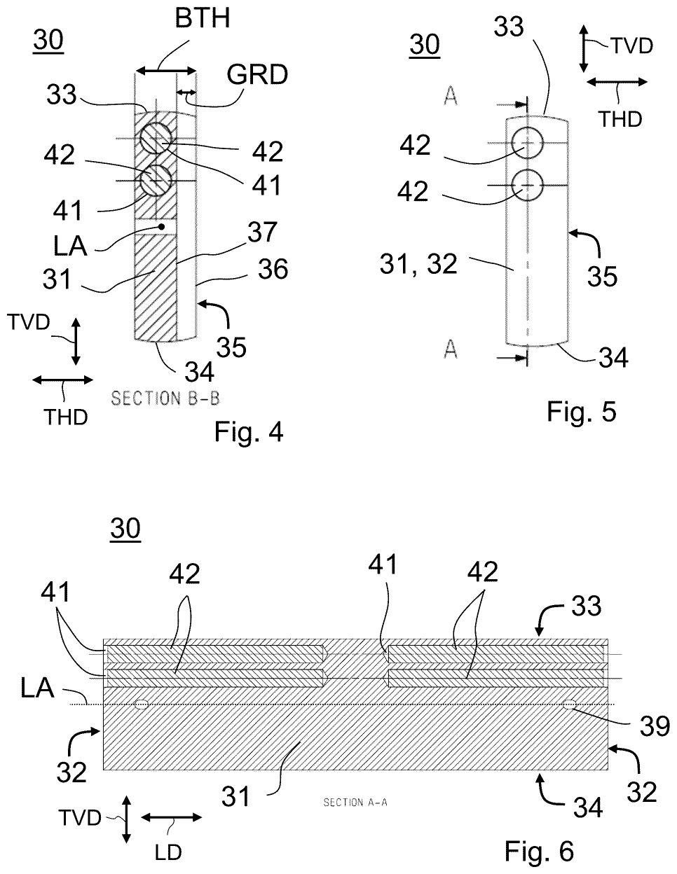

FIG. 4 shows a cross-sectional view of section B-B in FIG. 3. The cavities 41 are arranged distanced to outer geometries of the body 31 (the outer side 33, the side surface 35, the grooves 37, the ridges 36, etc.). Apart from the openings at the longitudinal end faces 32, the cavities are fully enclosed by the body 31 and hence from the fiber polymeric material.

The grooves 37 allow a fluidic communication between the displacement space 23 for the vane and the adjacent pressure chamber 24. When the vane 30 is pushed into to the corresponding displacement space 23, fluid gathered in the displacement space 23 is displaced by the vane 30. When the vane 30 is moved radially outwardly, fluid needs to flow into the displacement space 23. The grooves 37 allow fluid flow into the displacement space 23.

By providing the grooves 37 having a depth GRD of e.g. at least 31% or at least 35% of a thickness BTH of the body 31 and/or the groove width GRW being twice the ridge width RW of the ridges 12, an effective flow cross-section of the grooves 37 is large enough to ensure that fluid can easily flow between the displacement space 23 and the corresponding pressure chamber 24.

In an example, the grooves 37 have the depth GRD of about 40% of the thickness BTH of the body 31 (along the thickness direction THD). In longitudinal sections of the body 31 where both one of the grooves 37 and at least one of the cavities 41 are provided, the cavities 41 are arranged within the remaining 60% of the thickness BTH of the body 31.

The dimensions of the grooves 37 should be as big as possible to allow a good flow between the displacement space 23 and the pressure chamber 24, while the vane 30 should be as solid as possible to guarantee for the provided properties and reliability of the vane cell machine 1. Furthermore, the ridges 36 need to provide a good guidance of the vane 30 in the corresponding vane mount 22 with low friction. Thus, there needs to be a compromise between the dimensions of the groove 37, the strength of the vane 30, and the manufacturing costs. This is possible with the present invention.

FIG. 6 shows the cross section B-B of the vane 30 in FIG. 3. In total, the body 31 comprises four cavities 41. From each of the two longitudinal end faces 32, two cavities 41 extend along the longitudinal direction LD, respectively.

In FIG. 4, cavity axes of the upper cavities 41 coincide and cavity axes of the lower cavities 41 coincide. All cavity axes are parallel to the longitudinal direction LD.

In this example, all cavities 41 are completely separated from each other within the body 31.

Each cavity 41 is equipped with one weight insert 42. The weight inserts 42 have been inserted into the corresponding cavities 41. The weight inserts 42 may be additionally fixed in the corresponding cavities 41, for example by using adhesive.

The weight inserts 42 are made of a material being denser than the material of the body 31. In other words, the weight inserts 42 are made of a material having a mass density higher than a mass density of the fiber polymeric material of the body 31.

By the insertion of the weight inserts 42, the mass of the vane 30 (including the body 31 and the weight inserts 42) is increased and adapted to a desired target mass. The target mass is, on the one hand, as low as possible but, on the other hand, high enough that the vane 30 is subject to sufficient centrifugal force during operation of the vane cell machine 1 for ensuring proper sealing of the outer side 33 with the inner circumferential wall surface 12 of the stator 10. The vane cell machine 1 hence can be free of biasing elements (like springs) for urging the vanes 30 with an elastic force against the inner circumferential wall surface 12 (i.e. radially outwardly).

The weight inserts 42 are, for example, formed of a material of the group of steel, stainless steel, bronze, other metals, polymers filled with particles denser than the fibers (e.g. metallic particles), or the like. Especially, the weight inserts 42 can be made of stainless steel. This ensures good corrosion resistance, e.g. against salt/sea water, and sufficient high density.

The weight inserts 42 are arranged distanced to/recessed from the respective longitudinal end face 32, for example by at least 0.2 mm.

The weight inserts 42 are protected by the fiber polymer composite of the body 31 surrounding the cavities 41 (expect at the openings of the cavities 41 at the longitudinal end faces 32).

Regarding the vane 30, only the body 31 slides against other parts of the vane cell machine 1 during operation. The weight inserts 42 do not slide against other parts.

All vanes 30 provided within the same vane cell machine 1 may differ in their weights by max. 5%. This allows a smooth operation of the vane cell machine 1. The technology of inserting suitable weight inserts 42 allows adjusting the masses of all vanes 30 sufficiently precisely to the same, common target mass.

Naturally, embodiments with other numbers of cavities 41 and/or other numbers of weight inserts 42 are possible.

For example, in a further embodiment (not shown), six cavities 41 for insertion of weight inserts 42 are formed in the body 31 and the vane 30 comprises six weight inserts 42.

In a modification (not shown), the body 31 comprises two cavities 41 that extend between the two longitudinal end surfaces 32—for example as if the two upper cavities 41 in FIG. 6 were extended and merged and the two lower cavities 41 in FIG. 6 were extended and merged. Two weight inserts 42 might be inserted into each long cavity such that the arrangement of the weight inserts 42 is similar as in FIG. 6. Alternatively, one longer weight insert might be inserted into each long cavity.

The vane 30 can be comparatively large. For example, a length of the vane 30 in the longitudinal direction LD could be more than 100 mm, e.g. at least 130 mm. Additionally or alternatively, the thickness BRT of the vane could be more than 10 mm, e.g. at least 12 mm.

Of course, other sizes are possible as well.

As an example, the vane 30 can be manufactured as follows:

A precursor body (a raw body) of solid fiber polymeric composite is provided.

The polymer used for the fiber polymer composite is, for example, polyether ether ketone (PEEK). This material has good sliding properties in combination with fluid, like water, and steel.

The fibers might be provided in form of a fabric, prepreg, chopped, or the like. In one embodiment, the fibers include carbon fibers. Especially, all fibers can be carbon fibers. Carbon fiber reinforced polymers are in tendency, e.g. compared to aramid fiber reinforced polymers, less prone to a degradation of properties by the influence of fluids, like water.

For example, the precursor boy is made of a fiber reinforced polymer laminate with two fiber directions offset at 900 to each other. In one embodiment, manufacturing the precursor body might include:
laminating unidirectional carbon-fiber reinforced plies (e.g. prepreg plies) and/or
laminating woven carbon-fiber reinforced plies (e.g. prepreg plies), especially with orthogonal fiber directions.

The outer shape of the body 31 is formed by machining, e.g. by milling and/or drilling.

The final dimensions (e.g. the length along the longitudinal direction LD, a width along the traverse direction TVD, and the thickness BTH along the thickness direction THD) may be obtained my machining.

The shapes of the outer side 33 and/or the inner side 34 can be formed by machining.

The grooves 37 might be formed by machining.

The cavities 41 in the body 31 can be formed directly during production of the fiber polymeric composite. However, it is particularly cost-efficient and easy to form the cavities 41 by machining, for example by drilling.

In an insertion step, the weight inserts are inserted into the cavities 41. The method my additionally include fixing the weight inserts 42 to the body 31, e.g. by means of a bonding agent; in other words, the weight inserts 42 are glued in place.

The method can include forming handling features 39, e.g. by machining, in the precursor body and/or in the body 31, in order to facilitate handling during further manufacturing of the vane 30 and/or mounting of the vane 30 to the rotor 20.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A vane for a vane cell machine, wherein the vane cell machine includes a stator with a stator bore and a rotor arranged rotatably in the stator bore, the stator having an inner circumferential wall surface,
wherein the vane includes a body extending in a longitudinal direction), a traverse direction, and a thickness direction, wherein all directions are at least substantially perpendicular to each other, wherein the body comprises two opposite longitudinal end surfaces along the longitudinal direction and an outer side for sealing against the inner circumferential wall surface of the stator, wherein the outer side constitutes one end of the body in the traverse direction,
wherein the body is made of solid fiber polymeric composite and that the vane comprises at least one weight insert, wherein at least one cavity for insertion of the at least one weight insert into the body is formed in the body.

2. The vane according to claim 1, wherein the at least one cavity is arranged off-center towards the outer side relative to a central longitudinal axis of the body.

3. The vane according to claim 1, wherein the at least one cavity extends from one of the longitudinal end faces along the longitudinal direction into the body.

4. The vane according to claim 3, wherein a length of the at least one cavity is at least 0.2 mm longer than a length of the at least one weight insert.

5. The vane according to claim 3, wherein the body comprises a further cavity extending from the other one of the longitudinal end faces along the longitudinal direction into the body, wherein the at least one cavity and the further cavity are distanced to each other along the longitudinal direction.

6. The vane according to claim 1, wherein the body comprises, on a side face forming one end of the body in the thickness direction, grooves extending in the traverse direction, wherein the grooves have a depth of at least 31% of a thickness of the body along the thickness direction.

7. The vane according to claim 1, wherein the at least one weight insert is formed of a material having a higher mass density than the fiber polymeric composite and/or wherein the at least one weight insert is formed of stainless steel.

8. The vane according to claim 1, wherein the fiber polymeric composite includes polyether ether ketone and carbon fibers.

9. The vane according to claim 1, wherein the fiber polymeric composite is formed of a laminate, preferably with two fiber directions offset at 90° relative to each other.

10. The vane according to claim 1, wherein the at least one weight insert is fixed within the at least one cavity, preferably by means of an adhesive.

11. A vane cell machine comprising:
a housing having a stator with a stator bore;
a rotor mounted in the stator bore and configured for rotation relative to the stator about a rotational axis; and
a plurality of vanes mounted to the rotor such that the vanes are rotationally fixed to the rotor but such that limited displacement of the vanes in a radial direction is allowed;
wherein at least one of the vanes is a vane to any one of the preceding claims.

12. The vane cell machine according to claim 11, wherein relative weight differences between the vanes are less than 5%.

13. A method for producing vanes, according to claim 1, wherein the method comprises the following steps:
providing a body of the vane, wherein the body is made of solid fiber polymeric composite;
forming, in the body, at least one cavity for insertion of at least one weight insert; and
inserting the at least one weight insert into the empty at least one cavity.

14. The method according to claim 13, wherein a mass of the vane is tuned towards a target mass by inserting the at least one weight insert.

15. The method according to claim 13, wherein grooves are machined into the body.
